(19) United States
(12) Patent Application Publication
(10) Pub. No.: US 2026/0291835 A1
(43) Pub. Date: Sep. 24, 2026

(54) WIRELESS TRANSMIT/RECEIVE UNIT SIGNALING AND PROCEDURES FOR NETWORK SIDE DATA COLLECTION

(71) Applicant: InterDigital Patent Holdings, Inc., Wilmington, DE (US)

(72) Inventors: Anouar Yatribi, London (GB); Mihaela Beluri, Jericho, NY (US); Ahmet Serdar Tan, London (GB); Zihao You, Brooklyn, NY (US); Dylan Watts, Montreal (CA); Oumer Teyeb, Montreal (CA); Keya Patani, London (GB); Patrick Tooher, Montreal (CA)

(73) Assignee: InterDigital Patent Holdings, Inc., Wilmington, DE (US)

(21) Appl. No.: 19/088,360

(22) Filed: Mar. 24, 2025

(51) Int. Cl. H04L 43/04; G06F 16/215

(52) U.S. Cl. CPC H04L 43/028; H04L 43/04; H04L 43/06; H04L 43/08

(57) ABSTRACT

A wireless transmit/receive unit (WTRU) comprising a processor is disclosed. The processor is configured to receive configuration information indicating information related to ground-truth reporting. The processor is further configured to determine a plurality of ground-truth samples based on one or more received reference signals and determine one or more metrics associated with the plurality of ground-truth samples. The processor is further configured to determine one or more data quality indicators associated with the plurality of ground-truth samples based on the one or more metrics and the configuration information. The processor is further configured to determine a subset of ground-truth samples of the plurality of ground-truth samples based on the one or more data quality indicators, the threshold associated with ground-truth filtering, and the plurality of ground-truth samples, and send the subset of ground-truth samples to the network.

### BACKGROUND

Network side data collection for model training, fine-tuning, and/or or monitoring requires a wireless transmit/receive unit (WTRU) or a set of WTRUs to measure and report ground-truths (e.g., actual measurements). For AI/ML-based Channel State Information (CSI) enhancement (CSI compression and/or CSI prediction), the ground-truth samples are large, which leads to high signaling overhead for reporting sufficient samples to build network side datasets.

Depending on the purpose of data collection, a WTRU may need to report, in addition to ground-truth samples, the compressed CSI samples (e.g., for CSI compression use case) to enable the network to calculate key performance indicators. The WTRU may also need to report a set of samples within a configured observation window for training or fine-tuning models that leverage the temporal properties of the channel (e.g., in addition to the spatial and frequency domain properties), as well as applicable conditions to make sure that the reported ground-truth samples are aligned with the associated conditions configured by the network with respect to the AI/ML model. This additional information has the potential to further increase the overhead.

Therefore, solutions are needed to determine the quality of the data and reduce the overhead in reporting ground-truth samples for network side data collection.

### SUMMARY

An example wireless transmit/receive unit (WTRU) is disclosed that includes a processor. The processor is configured to receive configuration information, wherein the configuration information indicates information related to ground-truth reporting, and wherein the information related to ground-truth reporting comprises data quality criteria, a data quality indicator, and a threshold associated with ground-truth filtering. The processor is further configured to determine a plurality of ground-truth samples based on one or more received reference signals and determine one or more metrics associated with the plurality of ground-truth samples based on the data quality criteria. The processor is further configured to determine one or more data quality indicators associated with the plurality of ground-truth samples based on the one or more metrics and the data quality indicator configuration. The processor is further configured to determine a subset of ground-truth samples of the plurality of ground-truth samples based on the one or more data quality indicators, the threshold associated with ground-truth filtering, and the plurality of ground-truth samples, and send the subset of ground-truth samples to the network.

In examples, the data quality indicator configuration comprises an indication of a mapping function. In examples, the information related to ground-truth reporting comprises parameters associated with the data quality criteria, an indication of a maximum buffers size, or a ground-truth data collection window. In examples, the parameters associated with the data quality criteria comprise one or more channel conditions (e.g., an indication of speed of the WTRU, an indication of Doppler spread, an RSRP value, an SINR value, or an SNR value), one or more data distribution parameters associated with a distribution of data (e.g., a mixed dataset for training a global model or a localized dataset for model fine tuning). In examples, the data quality criteria comprises one or more channel conditions, an indication of a data distribution, an indication of data completeness, or an indication of a ground-truth diversity. In examples, the plurality of ground-truth samples comprise a measurement associated with a channel, an eigen vector of the channel, or a linear (e.g., pre-processing) transformation of the channel (e.g., in angular, delay, and/or Doppler domain). In examples, the processor is configured to send the data quality indicators associated with the subset of ground-truth samples to the network. In examples, the processor is configured to determine the one or more data quality indicators associated with the plurality of ground-truth samples based on two or more functions. In examples, the processor is configured to determine a reporting mode for the subset of ground-truth samples based on an amount of data stored in a buffer, an availability of uplink resources, or a data collection purpose provided via the information related to ground-truth reporting and send the subset of ground-truth samples to the network based on the reporting mode, wherein the reporting mode is associated with layer 1 signaling or layer 3 signaling. In examples, the processor is configured to determine a distance between the subset of ground-truth samples and a configured distribution and determine whether the send subset of ground-truth samples to the network using layer 1 signaling or layer 3 signaling based on the distance between the subset of ground-truth samples and the configured distribution.

An example method performed by a Wireless Transmit/Receive Unit (WTRU) is disclosed. The method involves receiving configuration information, wherein the configuration information indicates information related to ground-truth reporting, and wherein the information related to ground-truth reporting comprises data quality criteria, a data quality indicator, and a threshold associated with ground-truth filtering. The method further comprises determining a plurality of ground-truth samples based on one or more received reference signals and determining one or more metrics associated with the plurality of ground-truth samples based on the data quality criteria. The method further comprises determining one or more data quality indicators associated with the plurality of ground-truth samples based on the one or more metrics and the data quality indicator configuration. The method further comprises determining a subset of ground-truth samples of the plurality of ground-truth samples based on the one or more data quality indicators, the threshold associated with ground-truth filtering, and the plurality of ground-truth samples, and sending the subset of ground-truth samples to the network.

In examples, the data quality indicator configuration comprises an indication of a mapping function. In examples, the information related to ground-truth reporting comprises parameters associated with the data quality criteria, an indication of a maximum buffers size, or a ground-truth data collection window. In examples, the parameters associated with the data quality criteria comprise one or more channel conditions (e.g., an indication of speed of the WTRU, an indication of Doppler spread, an RSRP value, an SINR value, or an SNR value), one or more data distribution parameters associated with a distribution of data (e.g., a mixed dataset for training a global model or a localized dataset for model fine tuning). In examples, the data quality criteria comprises one or more channel conditions, an indication of a data distribution, an indication of data completeness, or an indication of a ground-truth diversity. In examples, the plurality of ground-truth samples comprise a measurement associated with a channel, an eigen vector of the channel, or a linear (e.g., pre-processing) transformation of the channel (e.g., in angular, delay, and/or Doppler domain). In examples, the method comprises sending the data quality indicators associated with the subset of ground-truth samples to the network. In examples, the method comprises determining the one or more data quality indicators associated with the plurality of ground-truth samples based on two or more functions. In examples, the method comprises determining a reporting mode for the subset of ground-truth samples based on an amount of data stored in a buffer, an availability of uplink resources, or a data collection purpose provided via the information related to ground-truth reporting and send the subset of ground-truth samples to the network based on the reporting mode, wherein the reporting mode is associated with layer 1 signaling or layer 3 signaling. In examples, the method comprises determining a distance between the subset of ground-truth samples and a configured distribution and determining whether the send subset of ground-truth samples to the network using layer 1 signaling or layer 3 signaling based on the distance between the subset of ground-truth samples and the configured distribution.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart diagram illustrating an example method according to an embodiment.

### DETAILED DESCRIPTION

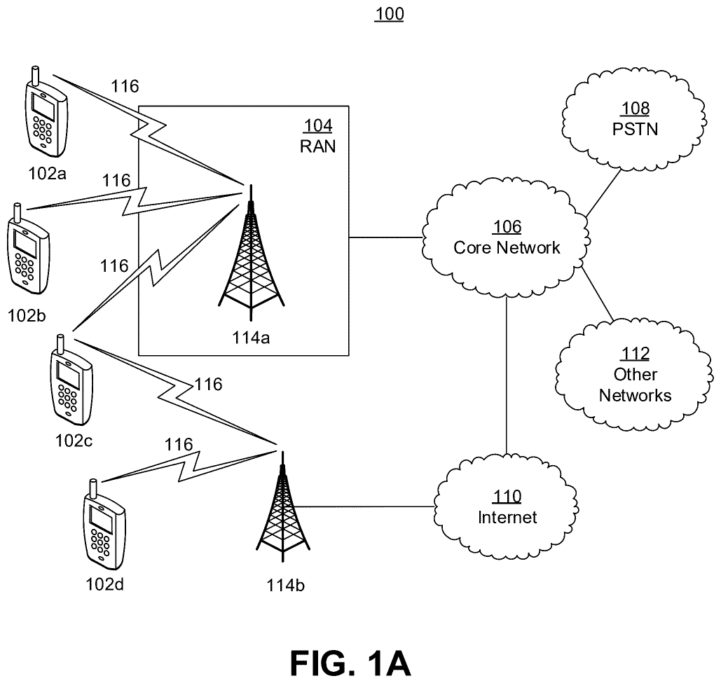

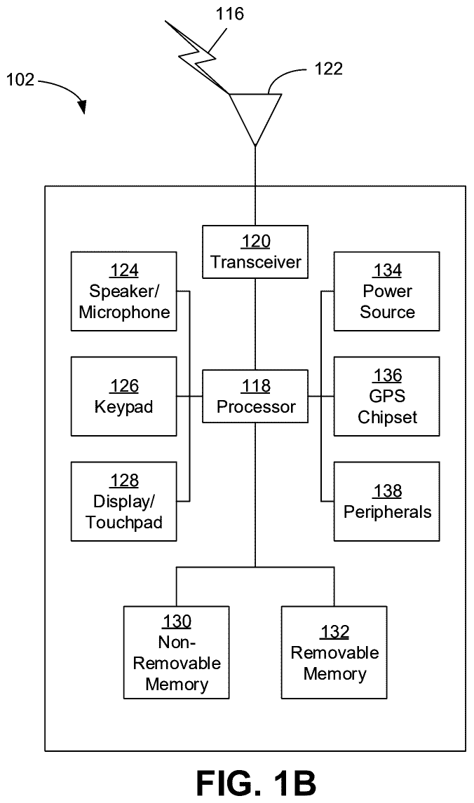

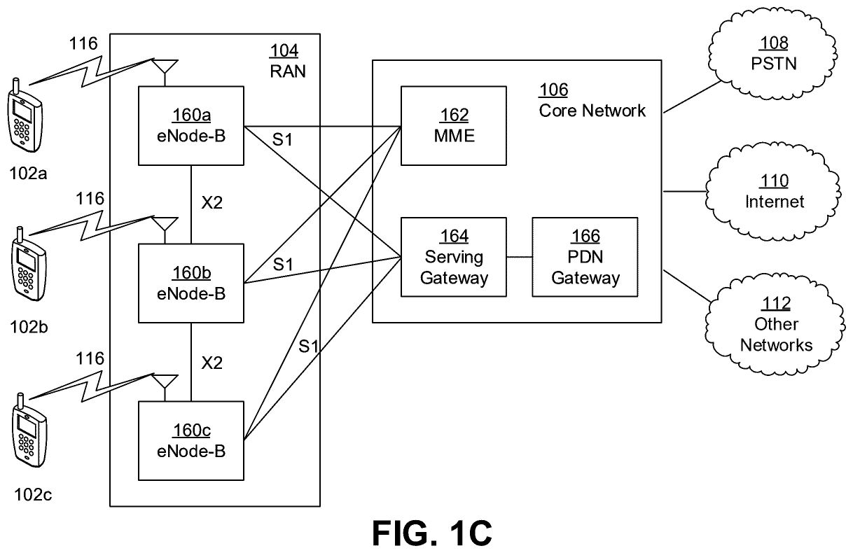

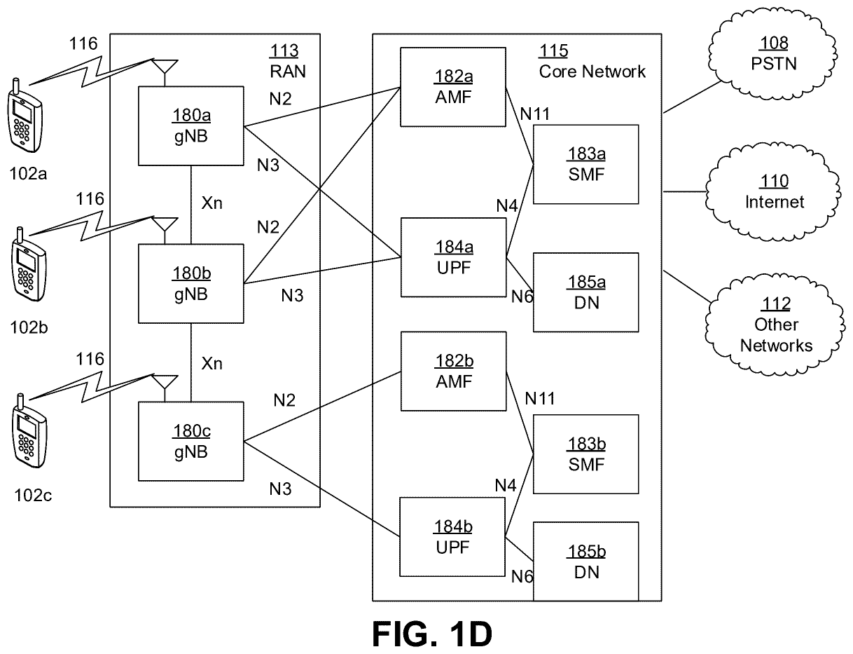

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the artificial intelligence/machine-learning (AI/ML) frameworks, life cycle management (LCM) procedures are needed for any one-sided and two-sided AI/ML model to ensure continuous stable performance under different scenarios, with efficient scalability and generalization capabilities. There are different LCM functions used for different purposes (e.g., training, fine-tuning, and performance monitoring). For two-sided AI/ML models, there are different approaches to training, such as sequential training (e.g., for autoencoders the encoder is trained first, followed by decoder training) and joint training (e.g., the encoder and decoder are trained jointly in the same loop). An AI/ML model can be trained offline then deployed for inference. Additionally, or alternatively, an AI/ML model can be trained online. Additionally, or alternatively, an AI/ML model can be pre-trained offline using synthetic datasets, then deployed and fine-tuned or re-trained online using real-field datasets. Performance monitoring is a key necessary LCM function to ensure efficient inference and scalability to different scenarios and applicable conditions.

When an AI/ML model is deployed, data collection is necessary to gather a sufficient dataset to apply any LCM function (e.g., model training, fine-tuning, and performance monitoring). For example, for a two-sided AI/ML based CSI compression use case, network side data collection is needed for the network to collect datasets and ground-truth samples for training, fine-tuning, and performance monitoring. In another example, network side data collection may be used for training a network side localized model, by collecting data from WTRUs operating in the same associated conditions and same cell/site/area. The terms “data”, “ground-truth”, and “ground-truth sample” are used interchangeably herein.

In some examples, a ground-truth may refer to the accurate, real-world data or labels used as a benchmark to train and evaluate an AI/ML model (e.g., a ground truth may be what the AI/ML model is supposed to learn or predict).

In some examples, a ground-truth may refer to the correct label for a dataset used to train AI/ML models. For example, an output of an AI/ML model may be compared to the ground-truth to measure the performance of the AI/ML model (e.g., for model validation). For example, in case of auto-encoder (AE) based CSI compression, the ground truth may be the true channel response (e.g., the raw channel matrix or eigenvectors of the channel) expected at the output of the decoder part of the AE. For CSI prediction, the ground truth may be the true channel response at the prediction instance.

AI/ML based channel state information (CSI) enhancements are being studied for the new radio (NR) air interface. One objective is to improve the tradeoff between performance and complexity and overhead. Network side data collection is important, as it enables continuous functioning of AI/ML models for two-sided AI/ML models for CSI compression, as well as for the case of network side one-sided AI/ML models (e.g., network side CSI prediction). For example, in a CSI compression use case, network side data collection is necessary for different LCM functions, such as training, fine-tuning and performance monitoring of network side AI/ML models. Network side data collection requires the WTRU to perform a CSI Reference Signal (RS) measurement, where channel estimation is performed to obtain a ground-truth estimate of the channel. Depending on the purpose of network side data collection (e.g., training, fine-tuning, and/or monitoring), the WTRU needs to transmit the ground-truth samples to the network, in addition to compressed CSI samples (e.g., for CSI compression use case), by inferring the WTRU-side encoder to enable the calculations of key performance indicators. The network receives a set of ground-truth samples and associated compressed samples to perform training, fine-tuning, and/or performance monitoring. Further, the WTRU needs to additionally report the temporal observation window when training AI/ML models that use the temporal properties of the channel. The number of CSI instances may depend on the deployed AI/ML model. Additionally, the WTRU may need to report applicable conditions if configured, given that the network side AI/ML model can only operate on specific configured associated conditions for each AI/ML model.

Network side data collection requires a significant signaling overhead to collect a sufficient number of samples for any LCM purpose, which in turn may impact the efficiency of the LCM functions and the system's overall performance.

A WTRU capable of assisting network-side data collection for AI/ML-based CSI processing, the following aspects are addressed: (a) methods for the WTRU to determine the quality of the ground-truth samples; (b) methods for the WTRU to filter the measured ground-truth samples (e.g., to reduce the signaling overhead); and (c) methods for the WTRU to select a ground-truth reporting mode based on the configured UL resources and data collection purpose.

In one embodiment, a WTRU may receive configuration information for ground-truth reporting for network side data collection (e.g., for AI/ML model training, fine-tuning and/or monitoring), measure the ground-truths (e.g., CSI), and determine one or more data quality indicators for the one or more measured ground-truths. The WTRU may filter the one or more measured ground-truths based on the determined one or more data quality indicators and configured thresholds, and select a ground-truth reporting mode as a function of the stored ground-truth data, available uplink (UL) resources and/or data collection purpose.

In one embodiment, a WTRU may receive configuration information. The configuration information may indicate information related to ground-truth reporting (e.g., for network side data collection). The configuration information may include one or more of: (a) criteria for data quality determination (channel conditions/associated conditions, data distribution, data completeness, diversity of the ground-truth); (b) parameters (or ranges of parameters) corresponding to configured criteria, such as (i) channel conditions (e.g., WTRU speed, Doppler spread, Reference Signal Received Power (RSRP), Signal to Interface plus Noise Ratio (SINR), Signal to Noise Ratio (SNR)), and/or (ii) data distribution parameters for: first distribution (e.g., a mixed dataset for training a global model) or second distribution (e.g., a localized dataset for model fine tuning); (c) configuration for data quality indicator determination (e.g., mapping function); (d) thresholds for ground-truth filtering; (e) data collection purpose (training, fine tuning, monitoring); (f) maximum buffers sizes—e.g., for training buffer, fine-tuning buffer; and/or (g) ground-truth data collection window.

The WTRU may measure one or more ground-truths (e.g., CSI) on one or more received reference signals to determine one or more ground-truth samples. The WTRU also measures metrics for one or more configured criteria for data quality determination. A ground-truth sample measurement may be one or more of: a raw measured channel, eigen vectors of the measured channel, a linear (e.g., pre-processing) transformation of the measured channel, for example when the ML model operates in angular, delay, and/or Doppler domain.

The WTRU may determine one or more data quality indicators (DQI) for the one or more ground-truth samples based on the measured one or more ground-truths and the configured mapping function.

The WTRU may filter the one or more ground-truth samples based on the determined one or more DQI, the configured ground-truth filtering thresholds, and previously stored filtered ground-truths. Additionally, the WTRU may store the one or more ground-truth samples based on the determined one or more DQI, the configured ground-truth filtering thresholds, and previously stored filtered ground-truths. The WTRU may store a ground-truth sample in a second buffer (e.g., fine-tuning buffer) when the ground-truth sample distance to a second (e.g., localized) distribution is below a second configured threshold. The WTRU may store a ground-truth sample in a first buffer (e.g., the training buffer) when the ground-truth sample distance to a first (e.g., mixed) distribution is below a first configured threshold. The WTRU may store a ground-truth sample in a third buffer (e.g. monitoring buffer) if the configured data collection purpose is monitoring or when the ground-truth sample is out of distribution (OOD) with respect to both the first and second distribution.

The WTRU may select a reporting mode for the one or more stored ground-truth samples in a buffer, as a function of stored ground-truth data in the buffer, available UL resources and data collection purpose. For example, in one embodiment, the WTRU selects L1 reporting when reporting the stored ground-truth sample in a third buffer, and L3 reporting when reporting the stored ground-truth sample in a first or second buffer.

The WTRU may report the one or more ground-truth samples, which may be stored in a buffer, in the selected UL resource. The WTRU may also report the DQI of the one or more ground-truth samples in a buffer.

The foregoing process reduces the network side data collection overhead by enabling the WTRU to determine the quality of the ground-truth sample, to filter out data that doesn't meet configured criteria requirements, to transmit to the network only data that meets configured quality requirements, and to select the reporting mode based on resource availability and data collection purposes (e.g., training, fine-tuning and/or model monitoring).

A WTRU with AI/ML capability receives configuration information to measure and report data, such as ground-truth samples, for a configured AI/ML functionality, to enable data collection (e.g., network side data collection). The configuration information may include criteria for data quality evaluation, parameters corresponding to configured criteria, configuration for data quality indicator (DQI) determination, data (e.g., ground-truth) filtering parameters, data collection purpose, and/or configuration of the resources for data reporting.

The WTRU may receive configuration information for a set (e.g., one or more) of criteria for data quality evaluation, where the set of criteria may include channel and/or applicable conditions, data distribution, data completeness, and/or data diversity. The channel and/or applicable conditions criterion may include one or more of the following: (a) alignment of measured conditions with the configured applicable conditions, where applicable conditions may include, but are not limited to, WTRU speed, WTRU antenna configuration, and/or frequency band; (b) alignment of measured channel conditions with the configured channel conditions, where the channel conditions may include one or more of the following: (i) doppler spread, RSRP, SINR, and/or SNR, (ii) channel estimation accuracy, (iii) time-variability of the channel (e.g., the WTRU may evaluate the time-variability of the channel based on measured Doppler, Time Domain Channel Property (TDCP), coherence time of the channel, and/or WTRU speed); and/or (iv) coherence bandwidth of the channel.

The data distribution criterion refers to the alignment between the measured data and the configured target data distribution. The data may refer to one or more of the following: (a) data at the input of a WTRU-side AI/ML model (e.g., a WTRU-side AI/ML model for use cases including CSI compression, CSI prediction, beam management, positioning, and/or RS overhead reduction); and/or (b) data in the latent space of the AI/ML model, for example in case of AI/ML based CSI compression.

The WTRU may evaluate a score for the data distribution criterion, for example using OOD metrics, geometric distances, statistical distances, and/or manifold distances between the current data measured by the WTRU and the configured target distribution. In one embodiment, the WTRU may be configured to save and report only data within the configured target distribution or within a configured distance from the target distribution.

The data completeness criterion refers to scenarios where a sub-set of the data samples may be missing. For example, in case of temporal WTRU-side AI/ML CSI compression or WTRU-side AI/ML CSI prediction, one or more samples in the configured observation window are not available. In another example, data may not be available when the WTRU may not have available CPU resources for inference, monitoring or measurement. In another example, the WTRU may not be able to collect data (e.g., CSI data) due to high interference (e.g., CSI-RS interference).

The data diversity criterion refers to the statistical properties of the already gathered data, with respect to the configured target distribution. For example, in one embodiment, when the target distribution is comprised of several (e.g., more than one) clusters (e.g., with different mean/median values) and the data saved at the WTRU-side does not include sufficient statistics for each cluster, the data diversity criterion may be assigned a low score. In one embodiment, when the data saved at the WTRU-side includes sufficient statistics for each cluster of the target distribution, the WTRU may assign a high score for the data diversity criterion.

The WTRU may receive configuration for the parameters or ranges of parameters corresponding to the configured criteria for data quality evaluation, for example for the channel and/or applicable conditions criterion, the data distribution criterion, the data completeness criterion, and/or the data diversity criterion.

Parameters for the channel conditions criterion may include one or more of the following: (a) WTRU speed or range of WTRU speeds; (b) Doppler or Doppler range; (c) coherence time of the channel or range of coherence time of the channel; (d) coherence bandwidth of the channel or range of coherence bandwidth of the channel; (e) SNR, SINR, RSRP, or ranges for SNR, SINR, and/or RSRP; and/or (f) TDCP or range of TDCP values.

Parameters for the applicable conditions criterion may include one or more of WTRU antenna configuration, WTRU battery status, and/or time of day.

In one embodiment, the WTRU may be configured to measure, and/or store and/or report data within the configured ranges. More particularly, the WTRU may only report data if the WTRU determines it is within the configured ranges.

Parameters for the data distribution criterion may include (a) distribution parameters for a mixed dataset (e.g., for training a global model), distribution parameters for one or more localized datasets (e.g., for training a localized model, or for model fine tuning). The distribution parameters may include one or more of the following: (i) dataset ID; (ii) first and second order statistics for the distribution (e.g., probability density function (PDF), cumulative distribution function (CDF), mean, median, standard deviation, range, and/or interquartile range); and/or (iii) number of clusters in the distribution, mean/median values for each cluster, variance of data for each cluster. Parameters for the data distribution criterion may additionally, or alternatively, include one or more of the following: (b) distance type to be evaluated by the WTRU (e.g., geometric distances, statistical distances, and/or manifold distances); (c) thresholds or ranges for the configured distance type (e.g., the WTRU may be configured to store and report data when measured data is within the configured distance or range of distances from the configured target distribution); and/or (d) OOD detection parameters.

Parameters for the data completeness criterion may include one or more of the following: (a) one or more dimensions of missing components; (b) one or more thresholds and/or a minimum and maximum acceptable of missing components; and/or (c) input/output completeness. Regarding one or more dimensions of missing components, in one embodiment, a WTRU may be configured with one or more input/output dimensions where data completeness may be evaluated, such as spatial and/or temporal (e.g., missing sample within the observation window) and/or frequency (e.g., missing sub-bands) dimension. Regarding one or more thresholds and/or a minimum and maximum acceptable of missing components, in one embodiment, a WTRU may be configured with one or more thresholds. The configured thresholds may control the maximum tolerance of missing components in the configured dimensions (e.g., the number of missing components per dimension after which the ground-truth sample quality starts to be impacted). Regarding input/output completeness, in one embodiment, a WTRU may be configured to evaluate data completeness and/or missing components in the input space and/or in the latent space (e.g., in CSI compression use case).

Parameters for the data diversity criterion may include one or more of the following: (a) one or more statistical metrics to evaluate the diversity of the ground-truth sample(s) (e.g., probability density function (PDF), cumulative distribution function (CDF), mean, median, standard deviation, range, and/or interquartile range); (b) threshold or minimum number of ground-truth samples to use for the evaluation of diversity; (c) inter and/or intra distance evaluation of diversity (for example, a WTRU may be configured to evaluate the diversity (e.g., a distance metric) of the measured ground-truths with respect to each other (e.g., inter-samples), or with respect to one or more data cluster reference (e.g., if configured)); and/or (d) one or more thresholds for distance evaluation of the configured metric, such as a threshold on a statistical metric to classify a set of ground-truth samples as diverse (e.g., if the measured metric distance is above/below a threshold).

The configuration information for DQI determination may include one or more of the following: (a) an indicator for a first function (e.g., from a set of pre-defined first functions, where the first function may be used to determine the DQI as a function of the scores calculated for each configured criterion); (b) a set of weights for the configured criteria (e.g., when the first function is a linear combination of the criteria scores); and/or (c) indicator for a second function (e.g., from a set of pre-defined second functions, where the second function may be associated with a configured criterion and may be used to determine the criterion score as a function of the measurements associated to the criterion).

The WTRU may receive a data filtering configuration. The data filtering configuration may include one or more of the following (a) thresholds for criteria scores (e.g., when the DQI calculation uses binary values for each criterion, each criterion may be configured a minimum score; when the measured score for the criterion exceeds the configured minimum threshold, the binary value associated to the criterion may be set to 1, otherwise it may be set to 0); (b) thresholds for data quality indicators (e.g., when the WTRU is configured with thresholds for data quality indicators, the WTRU may save and/or report the ground-truth sample when the measured DQI exceeds the configured threshold, otherwise the WTRU may drop the ground-truth sample); and/or (c) maximum buffer size, where the buffer size may be different based on the data collection purpose (e.g., for model training, model fine-tuning and/or model monitoring).

The WTRU may receive configuration information to measure, store, and/or report data for one or more purposes, where the purpose of data collection may be model training, model fine-tuning, and/or model monitoring. The WTRU may receive configuration for the data collection window, for example window length, which may be expressed in units of time (e.g., ms, seconds, minutes), slots, TTIs, or in number of measurement occasions. The WTRU may receive configuration information for one or more data collection windows, where a window may be associated with a data collection purpose. For example, the WTRU may be configured to measure, store, and/or report data for model training purposes using a first data collection window and for model monitoring purposes using a second data collection window.

The WTRU may receive configuration for periodic, semi-persistent, or aperiodic reporting of the ground-truth sample data, including priorities for reporting when the total available data size exceeds the available reporting resources.

The WTRU may also be optionally configured with the content of data reporting. For example, the WTRU may be configured with one or more explicit and/or implicit DQIs (e.g., separate DQIs per each configured data quality criteria), and/or additional information (e.g., channel and/or applicable conditions), and/or compressed samples associated to the one or more ground-truth samples (e.g., in CSI compression use case).

A WTRU may be triggered to start the measurements for the purpose of network side data collection, which is needed by the network for model training, fine-tuning, and/or performance monitoring. The trigger may be configured to be periodic, semi-persistent, aperiodic, or event-triggered (e.g., network needs to fine-tune an AI/ML model, network detects performance drop, etc.).

Once triggered the WTRU is configured to collect the received reference signals (e.g., CSI-RS, Demodulation Reference Signal (DMRS), Secondary Synchronization Signal (SSS)) over one or more periods of time for one or more data collection windows. In one embodiment, the WTRU determines measures ground truths on one or more received reference signals and measures metrics for one or more configured criteria for data quality evaluation. The ground-truth samples and metrics measured in one data collection window may be configured to be different than another, for example, due to different data collection purposes, or due to multiple configured AI/ML models.

In one embodiment, a ground-truth sample measurement may be configured to be one or more of the following: (a) raw measured channel (e.g., if the configured AI/ML model requires a raw channel matrix as input); (b) one or more eigen vectors of the measured channel (e.g., if ground-truths are in EV format, one or more eigen vectors are measured as a function of the configured rank(s); (c) linear (e.g., pre-processing) transformation of the measured channel, for example when the AI/ML model operates in angular, delay, and/or Doppler domain.

In one embodiment, the ground-truths can be estimated, for example, from a set of reference signals (e.g., CSI-RS) in one or more TTIs. In one embodiment, if configured, the ground-truths can be estimated from a set of reference signals (e.g., CSI-RS) received across a configured data collection window. In one embodiment, the ground-truths can be estimated based on a configured maximum number of ground-truth measurements.

In one embodiment, data quality criteria measurements may be based on one or more of applicable conditions, channel conditions, and/or data completeness.

Regarding applicable conditions, if a WTRU is configured for a set of criteria for channel conditions, the WTRU may measure the applicable condition parameters corresponding to the configured criteria to check how the measured parameters align with the configured parameters. These parameters may include one or more of WTRU speed, WTRU antenna configuration, and/or frequency band.

Regarding channel conditions, the WTRU may measure the channel condition parameters corresponding to the configured criteria to check how the measured parameters align with the configured parameters, if the WTRU is configured for a set of criteria for channel conditions. The channel condition parameters may include one or more of Doppler spread, coherence time and bandwidth of the channel, RSRP, Received Signal Strength Indicator (RSSI), Reference Signal Received Quality (RSRQ), and/or SINR for wide-band and sub-band. In one embodiment, some of the channel condition parameters (e.g., Doppler spread and RSRP) can be estimated from the raw measured channel in one TTI. In one embodiment, some of the channel condition parameters (e.g., coherence time and bandwidth of the channel) can be estimated from the other channel condition parameters (e.g., Doppler spread) together with the applicable conditions (e.g., carrier frequency). If a data collection window is configured to cover multiple TTIs, the temporal correlation between the one or more ground-truths in different instances could be measured as configured.

Regarding data completeness, if a WTRU is configured for a set of criteria for data completeness, the WTRU may check if and where a sub-set of data samples is missing. In one embodiment, a WTRU may not have enough CPUs when multiple CSI-RS resources need to be processed simultaneously. In one embodiment, in case of Temporal-Spatial-Frequency CSI compression, a sub-set of samples in the configured observation window may not be available.

With the measured parameters for data quality criteria, the WTRU may be configured to compare some of the measured parameters to the corresponding configured parameter or range of parameters (if any) to find how they align with the configured conditions. The WTRU then proceeds to data quality evaluation.

The WTRU determines one or more data quality indicators (DQI) of one or more ground-truths as a function of the measured one or more ground-truths, the configured criteria and associated metrics, and the configured mapping function.

In one embodiment, the WTRU may determine the DQI based on a first function of the scores associated to each configured criterion or metric. In one embodiment, the scores may be attributed, for example, per configured criterion (e.g., channel and/or applicable conditions, distribution, etc.), wherein a configured criterion may have a score associated to it. The score may be based on whether the conditions implied by the configured criterion is met. The score may also capture the significance of the condition when met. In one embodiment, a score may be attributed per one or more metrics associated to one or more configured criterion.

The WTRU may determine the DQI based on a first function of the scores associated to each configured criterion. In one embodiment, a first function may be defined as a weighted function of the scores associated to each criterion. The weights may be network configured based on the importance of each criterion in the determination of a DQI. In one embodiment, such a first function can be defined as Equation 1:

$$DQI = f ( {x}_{1} , … , {x}_{n} ) = {\sum }_{i} {w}_{i} {x}_{i} \qquad Eq . 1$$

where x₁, . . . , xₙ represent the attributed scores associated to each configured criterion i, and the terms wᵢ represent the importance weights configured by the network for each configured criterion.

In one embodiment, the scores associated to each criterion may be defined as a binary function (e.g., indicator). For example, the scores xᵢ can be either 0 or 1, e.g., condition not met, and condition met, respectively. In one embodiment, the scores may be defined as real values belonging to the range [0, 1], e.g., reflecting a probability or a confidence score. In one embodiment, the scores may be defined as multi-level scores, e.g., integer values representing the confidence level corresponding to one or more configured criterion condition. In this solution, for example a score of 0 means a very poor ground-truth quality associated with a configured criterion.

In one embodiment, if specific metrics are configured by the network for each configured criterion, then the score associated to each criterion may be determined as a second function of the measured metrics associated to the configured criteria. For example, for the channel and/or applicable conditions criterion, the score may be determined using Equation 2:

$${f}_{conditions} = {α}_{speed} {f}_{speed} + {α}_{Doppler} {f}_{Doppler} + {α}_{TDCP} {f}_{TDCP} \qquad Eq . 2$$

where f_{conditions} is the first function associated to the channel and/or applicable conditions configured criterion, f_{speed}, f_{Doppler}, α_{TDCP} are second functions, and α_{speed}, α_{Doppler}, α_{TDCP} are the weights, corresponding to the measured metrics (e.g., UE speed, Doppler, and/or TDCP) associated to the configured metric thereof.

For the data distribution criterion, the score may be determined using Equation 3:

$${f}_{distribution} = {α}_{input \_ dist} {f}_{input \_ dist} + {α}_{latent \_ dist} {f}_{latent \_ dist} + {α}_{ood} {f}_{ood} \qquad Eq . 3$$

where f_{distribution} is the first function associated to the data distribution configured criterion, f_{input_dist}, f_{latent_dist}, α_{ood} are second functions, and α_{input_dist}, α_{latent_dist}, α_{ood} are the weights, corresponding to the measured metrics (e.g., input distribution, latent distribution, and/or OOD detection) associated to the configured metric thereof.

For the data completeness criterion, the score may be determined using Equation 4:

$${f}_{completeness} = {α}_{obs \_ win} {f}_{obs \_ wind} + {α}_{latent \_ dim} {f}_{latent \_ dim} \qquad Eq . 4$$

where f_{completeness} is the first function associated to the data completeness configured criterion, f_{obs_win}, f_{latent_dim} are second functions, and α_{obs_win}, α_{latent_dim} are the weights, corresponding to the measured metrics associated to the configured metric thereof. In this embodiment, the measured metrics are the number of missing samples in the observation window (e.g., in CSI compression temporal cases 1/2/3), and the number of missing parts of the encoder output (e.g., latent dimension), such as a missing sub-band, for example caused by unavailability of processing units during inference and/or channel estimation errors caused by CSI-RS interferences.

In one embodiment, for the diversity of ground-truth sample criterion, all the samples are below a distance from the median of the configured distribution.

In one embodiment, the WTRU may determine multiple DQIs for different configured criteria for more granularity (e.g., if the WTRU is configured to report the DQIs explicitly). In one embodiment, the WTRU may determine multiple sets of DQIs, for example, in case network side data collection is configured for multiple AI/ML models (e.g., with multiple configured criteria sets and associated measurement metrics thereof). In this embodiment, the WTRU may produce different sets of DQIs, wherein each set corresponds to a specific AI/ML model.

In one embodiment, the WTRU may filter one or more ground-truths based on the determined one or more DQIs, criteria scores, the configured ground-truth filtering thresholds and the maximum buffer size. The WTRU may determine the filtering action for the ground-truths if one or more of the following conditions is satisfied: (a) if the DQI/criteria score for one or more ground-truths are below the configured threshold; (b) if the DQI/criteria score for one or more ground-truths within a set of ground-truths collected within a measurement window are below a threshold relative to the sets DQI values/criteria score (e.g. more than n standard deviations away from the mean DQI); (c) if the joint DQI score/criteria score for a set of samples is below a configured threshold (e.g., if the average DQI score for n ground-truths is below a threshold, the WTRU may discard the whole set); and/or (d) if the buffer capacity is limited, the WTRU may choose a subset of n ground-truths with the highest DQI value/criteria score.

A WTRU configured with a data collection purpose and/or data collection window may store one or more ground-truths in one or more buffers. In one embodiment, the distance to a distribution/similarity value may be computed as a statistical distance (e.g. Kullback-Leibler, Wasserstein, and/or Z-score), likelihood value (e.g. output of a probability density function/density estimation model), geometric distance (e.g. Euclidean distance to cluster center, pairwise Euclidean distance, similarity value may be computed as a statistical distance (e.g. Kullback-Leibler, Wasserstein, and/or cosine similarity) and/or manifold distance (e.g. Grassman, similarity value may be computed as a statistical distance (e.g. Kullback-Leibler, Wasserstein, and/or chordal). In one embodiment, the WTRU may determine one or more buffers to store the ground-truths in based on one or more conditions. For example, the WTRU may store a ground-truth sample in a first buffer (e.g. the training buffer) if the ground-truth sample distance or similarity value to a first (e.g. mixed) distribution/target dataset is below a first configured threshold. The WTRU may store a ground-truth sample in a second buffer (e.g. the fine-tuning buffer) if the ground-truth sample distance or similarity value to a second (e.g. localized) distribution/target dataset is below a second configured threshold. The WTRU may store a ground-truth sample in a third buffer (e.g. monitoring buffer) if the configured data collection purpose is monitoring or if the ground-truth sample is OOD with respect to both the first and second distribution. The filtered ground-truths may be stored in task and/or configuration specific buffers (e.g. positioning model management buffer) if the WTRU is running one or more AI/ML models (e.g. a single multi-task AI/ML model or multiple task specific AI/ML models) for one or more tasks (e.g. CSI prediction, positioning, beam management, CSI compression) and/or one or more configurations (e.g. various SNR ranges, speeds, environments). The WTRU may store ground-truths in the model training buffer if they were collected within the measurement window and/or data collection purpose. The WTRU may choose to keep a ground-truth sample if its DQI is below a threshold, but it meets the distance threshold to a target distribution.

In one embodiment, the WTRU may report collected data differently depending on which buffer the data is stored within. Storing data “within a different buffer” may also include the scenario that a single buffer is partitioned, and data may be stored within different “logical” buffers, and/or all data is stored within a single buffer and given a different classification (i.e., a first, second and third). Such scenarios may be used interchangeably in embodiments described herein.

In one embodiment, the WTRU may report collected data via, for example, Radio Resource Control (RRC) signaling, Medium Access Control Channel Element (MAC CE), Non-Access Stratum (NAS), Uplink Control Information (UCI), Random Access Channel (RACH) (e.g., MSG1/3/5 and/or MSGA) and/or Physical Uplink Shared Channel (PUSCH)/Physical Uplink Control Channel (PUCCH). In one embodiment, data collected within a specific buffer may be assigned to one or more signaling methods. For example, a ground-truth sample which is stored within a first or second buffer may be reported via L3 signaling (e.g., RRC), whereas a ground-truth sample stored within a third buffer may be reported via L1/L2 signaling (e.g., MAC CE and/or UCI). Which signaling method is used for a given buffer may be configured within the data collection configuration. In one embodiment, the WTRU may be configured to only report data stored within a buffer via a specific signaling method. In one embodiment, the WTRU may be configured with multiple signaling methods, and the WTRU may choose which signaling method to transmit the collected data (e.g., based on availability of resources, characteristics of the stored data, buffer status etc.)

Additionally, or alternatively, which signaling method is used for transmission of collected data within a given buffer may depend on satisfaction of one or more criteria. For example, in one embodiment, the WTRU may be forbidden from transmitting collected data of a specific type via a certain type of signaling and/or within a specific RRC state. For example, the WTRU may transmit information sensitive to security and privacy (e.g., WTRU location information) only via specific signaling types (e.g., RRC signaling, or within RRC connected state. In one embodiment, the WTRU may transmit, for example, L3 measurements via RACH or random access signaling.

Additionally, or alternatively, the resources provided for transmission of the collected data may be insufficient to transmit all the data. For example, a WTRU configured to report collected data via one signaling method (e.g., UCI) may have insufficient resources to report the total amount of data. In one embodiment, the WTRU may report the data over multiple transmission instances. In another example, the WTRU may change the signaling type (e.g., use L3 signaling, MAC CE, etc.) which can transmit the entirety of collected data in a signaling transmission.

Additionally, or alternatively, the type of signaling may depend on the characteristics of the data collected within the configured buffer. For example, transmission of data which is time critical to receive (e.g., the validity of the data is about to expire, the buffer is full, high priority data etc.) may use L1/L2 signaling, which is generally considered faster. In another example, data which required high reliability may be transmitted via RRC signaling.

Additionally, or alternatively, which signaling is used for transmission of data within a specific buffer may depend on the termination point of the data. For example, data collected and sent to the gNB may use L1 or L3 signaling, whereas data which is to be sent to a network node (e.g., the LMF for positioning related data etc.) may use NAS signaling.

In one embodiment, a WTRU may be configured to indicate to the network that collected data is available if the collected data reaches a certain threshold or when the buffer is full. This could be configured for the total collected data (e.g., across different buffers used for the data collection) or it could be at each buffer level. This will enable the reporting of the collected data and making it possible for each collected more data. This, for example, could be an RRC message (e.g., a WTRUAssistanceInformation, or a new RRC message). In this message, the WTRU may include information about the collected data in this indication (e.g., total size, time of oldest sample, which buffer(s) triggered this report, statistical information about the data such as the mean/standard deviation of the ground-truth values, etc.).

In one embodiment, the network may send a request to the WTRU to report the collected data. This, for example, could be a WTRUInformationRequest or a new RRC message defined for this purpose.

In one embodiment, the request from the network may indicate the type of the data to be sent (e.g., in the case of different buffers, the data from which buffer(s) to be reported).

Additionally, or alternatively, the request from the network may indicate the amount of data to be reported (e.g., in actual bytes, e.g., Kbytes, in number of data samples, etc.).

Additionally, or alternatively, the request from the network may indicate time information of the collected data to be reported (e.g., data samples older than a certain absolute/relative time, data samples newer than a certain absolute/relative time, data samples between upper and lower time thresholds, etc.).

Additionally, or alternatively, the request from the network may indicate ground-truth thresholds of the collected data to be reported (e.g., with ground-truth values above a certain threshold, ground-truth values below a certain threshold, ground-truth values between two thresholds, etc.).

Additionally, or alternatively, the request from the network may indicate DQI values of the collected data to be reported (e.g., with DQI value equal to a certain value or within a set of values).

Additionally, or alternatively the request from the network may indicate some statistical criteria about the collected data to be reported (e.g., the ground-truth values that fall or do not fall within a certain standard deviation of a certain distribution of ground-truth values, etc.).

It should be noted that the different criteria can be combined within the same request from the network, and the WTRU may be configured to report the data that fulfills all the criteria or just one of the criteria.

In one embodiment, if the buffer is full, the WTRU may be configured to send the next data sample via L1 signaling instead of logging it. Additionally, or alternatively, the WTRU may be configured to send the oldest data sample (or the data sample with the highest ground-truth, or a certain DQI, etc.) using L1 signaling and store the new sample in the buffer.

In one embodiment, the WTRU may be configured to send the collected data only if it already has a grant available that is not needed for other purposes (e.g. to send other UP/CP data pending to be transmitted).

In one embodiment, the different buffers may be associated with different reporting priority, and this may further determine the mechanism used to report the data. For example, high priority data may be configured to use a signaling radio bearer (SRB) while a lower priority data may be configured to use a data radio bearer (DRB). For example, high priority data may be configured to use a DRB of high priority or higher maximum/guaranteed bit rate, while a low priority data may be configured to use a DRB of low priority or best effort bit rate.

In one embodiment, the WTRU may be configured to periodically report the collected data within a specific data collection buffer. The WTRU may have pre-configured resources (e.g., configured grants) in which to transmit the collected data. In case the WTRU has not collected any or sufficient data to transmit the collected data, the WTRU may simply skip the transmission occasion. In one embodiment, if the WTRU has a filled (or almost filled) data collection buffer prior to a transmission opportunity, the WTRU may either stop logging data (e.g., until the next transmission opportunity) or request additional transmission resources from the network.

In one embodiment, the WTRU may trigger reporting of the collected data upon satisfaction of one or more conditions and/or criteria. Examples of conditions/criteria to trigger transmission of collected data include, for example, one or more of the following: (a) periodically, (b) upon network request, (c) when a particular data collection buffer has become full, (d) when a particular data collection buffer is about to become full, (e) upon reaching a specific level of data for a particular data collection buffer, (f) upon reaching a specific level of data for a given data collection configuration, (g) when all data collection buffers have become full, (h) when all data collection buffers are about to become full, (i) upon reaching a threshold number of data entries, and/or (j) when a certain type of data meets a criterion (for example, a record of RSRP is above a threshold RSRP value).

In one embodiment, collected data stored within a specific buffer may be associated with one or more of the above criteria. In one embodiment, if an associated triggering criterion is satisfied, the WTRU may transmit only the data from the buffer associated with the criteria which was satisfied. In another embodiment, the WTRU may transmit the entire set of collected data.

The WTRU may select the appropriate signaling method for an UL resource to transmit the collected data within the given buffer upon satisfaction of criteria and/or request to transmit collected data. The WTRU may have insufficient resources for transmission of all data collection buffers if the criteria for transmission of collected data for multiple buffers is filled simultaneously. In this case, the WTRU may perform one or more of the following (a) transmit collected data associated with one or more buffers; (b) transmission of collected data associated with one or more buffers; (c) postpone transmission of collected data associated with one or more buffers; and/or (d) select an alternative signaling method to transmit data associated with one or more buffers.

Which action to perform for which data collection buffer may depend on, for example, the priority and/or characteristics of the data contained within the buffer, network configuration, DQI of data within the buffer, and/or the availability of alternative signaling methods.

In one embodiment, the network may control the transmission of collected data. In one embodiment, this may be via relying exclusively on network request, availability of resources, allowed signaling method, and/or configuration of transmission criteria. In one embodiment, whether the WTRU may transmit data for a given buffer may depend on satisfaction of a prohibit condition. For example, the WTRU may be restricted from notifying the network that a data collection buffer is full, or requesting resources to transmit collected data associated with a given data collection buffer. In another example, a data collection buffer may be configured with a prohibit timer, wherein upon transmission of a data collection report, the WTRU may be restricted from transmitting another data collection report until a duration of time (e.g., the prohibit timer) has completed. Prohibit conditions may be configured, for example, for all data collection transmission, or may be individually configured for each data collection buffer.

A WTRU configured to apply data quality evaluation and filtering for the reporting of the collected ground-truth samples may report one or more of the following to the network: (a) DQI, (b) ground-truth, (c) compressed CSI, (d) applicable conditions, (e) buffer ID, and/or (f) Dataset ID.

Regarding DQI reporting, the values of DQI may be quantized based on configuration information form the network. In one embodiment, the real valued DQI may be mapped to different levels to represent the quality of the data samples, wherein the DQI mapping can be linear, non-linear, or look-up table based. The WTRU may feedback one or more DQI values where each DQI may be associated with a single data sample (e.g., ground-truth) or a group of data samples (e.g., group of ground-truths).

Regarding ground-truth reporting, the WTRU feeds back the filtered ground-truth samples to the network where the associated DQI may indicate the quality of the ground-truth samples. The ground-truth samples may represent, for example, raw measured channel or eigen vectors of the measured channel. When the reported ground-truth samples are eigen vector based, the WTRU may further report the total rank and/or associated rank order of the corresponding eigen vector. In one embodiment, ground-truth samples may represent a linear (e.g., pre-processing) transformation of the measured channel, for example when the ML model operates in angular, delay, and/or Doppler domain. The payload size of each ground-truth sample may be based on the content of the ground-truth sample (e.g., channel matrix or channel eigenvector, etc.), the configured quantization level per sample and the DQI mapping method. The number of ground-truth data samples may be based on the outcome of the filtering process and based on the network configurations.

Regarding compressed CSI reporting, if configured, the WTRU may feedback compressed CSI samples associated with ground-truth samples to enable the network to compute key performance indicators and/or perform monitoring. In one embodiment, the compressed CSI may be associated with a subset of the reported ground-truth samples. In one embodiment, codebook-based compression methods may be used to create the compressed CSI samples. In one embodiment, AI-based compression methods (e.g., autoencoder based) may be used to create the compressed CSI samples.

Regarding applicable conditions reporting, the WTRU may report applicable conditions along with the filtered ground-truth samples, if configured by the network. The applicable conditions may consist of WTRU speed, Doppler, TDCP, WTRU location, time stamp, etc. For example, the WTRU may report the start time and the end time of the data collection. The WTRU may feedback an applicable condition associated with a single ground-truth sample or a group of ground-truth samples.

Regarding buffer ID reporting, in one embodiment, when the WTRU is configured to measure and report the ground-truth for one or more data collection purposes, the WTRU may indicate the buffer ID corresponding to the reported ground-truth, for example to enable the network to differentiate between ground-truth samples for model training, fine-tuning and/or monitoring.

Regarding dataset ID reporting, the dataset ID may be reported if configured by the network.

In one embodiment, when the WTRU is configured to report channel eigen vectors as the ground-truth samples, the WTRU may report one or more DQIs, wherein each DQI may be associated with a different eigenvector of the corresponding channel matrix when the rank is greater than 1. The DQI value for each rank may be specific for a given rank based on the received DQI configurations. In one embodiment, the WTRU may group eigenvector-based ground-truth samples according to total rank and/or rank order, then further group the ground-truth samples based on rank-based DQI and then report the ground-truth samples with associated DQI.

Although the foregoing description mainly focuses on AI/ML based CSI prediction/compression use cases, the embodiments description herein are equally applicable for any AI/ML based solution where data collection is desirable (e.g., for model training or performance monitoring purposes).

For each specific use case that will use the solutions above, different ground-truth and DQI determination configuration can be provided (e.g., for AI/ML based positioning, the ground-truth sample could be a GNSS or other location information and the DQI can be related to the positioning accuracy, or the signal level of the positioning reference signals, etc.).

Further, although the foregoing description mainly focuses on network side data collection, all of the embodiments are also applicable to WTRU side data collection (e.g., to be used for the training of a WTRU side model). In one embodiment, different actions are to be taken based on the ground-truth sample and/or DQI information (e.g., which buffer data is to be put into, priority the data needs to be sent, etc.), which may come from an entity outside the network (e.g., an OTT server where the WTRU sided model is to be trained). Additionally, or alternatively, it can come from the network as in the case of the data collection for the network side model training (e.g., the OTT server may inform the network via a proprietary interface about the required data collection configuration and the network can configure the WTRU on behalf of the OTT server).

In embodiments described above, the WTRU is configured to store the data in three different buffers depending on criteria such as the DQI, DQI threshold, and/or historical/stored data (e.g., one buffer for training purposes, one buffer for monitoring purposes, one buffer for fine-tuning purpose). However, this is just an example realization, and the WTRU may be configured to have n buffers, each with corresponding criteria. It should be noted that the WTRU may not necessarily be aware that the purpose of the different buffers and the reason for the configured criteria/thresholds, and may simply apply the configured behavior.

The WTRU may be configured to label the collected data differently based on the configured criteria instead of putting the data in different buffers. This could be combined with the different buffers (e.g., there could be one buffer for the collected data that was filtered based on the criteria corresponding to the fine-tuning and training as described above, and the WTRU may add an additional field in the collected data to distinguish between the two).

The criteria based on ground-truth value (e.g., DQI, statistical information of the collected data, etc.) could be used to determine whether the current collected sample should be logged or not, instead of determining which buffer it should be stored in or which label it should take.

There may be a maximum buffer size for each individual data collection buffer, or a maximum buffer size may be associated for the sum of all the different buffers. For example, in one embodiment where there are three buffers, there could be individual maximum buffer thresholds configured for each buffer, or one maximum buffer threshold configured (e.g., the sum of the collected data in the three buffers may not be more than this threshold).

The same approach could be used in an embodiment where labeling is used to differentiate the different collected data, rather than separating them into different buffers as described above (e.g., maximum size for each label/type and/or a maximum size for all label/types).

The WTRU may indicate the total buffer capacity that it has available for the case of data collection, and it may be up to the network to determine the proportion of the maximum size to be allocated for each buffer (or type/label if one buffer is used for mixed types of data) and configure the WTRU accordingly. Additionally, or alternatively, it may be that the WTRU determines the individual sizes for each buffer (or for each type/label).

The buffer sizes/limits discussed herein could be actual data sizes (e.g., in Kbytes, etc.) or it could be in the number of collected data samples.

The WTRU may be configured to drop/delete some collected data in the buffers to make room for a newer data if there is buffer overflow during data collection. In one embodiment, dropping/deleting some collected data may be based on a FIFO basis (e.g., First in, First Out) where the oldest data sample is deleted to make room for the newest one. Additionally, or alternatively, dropping/deleting some collected data may be based on the DQI or other parameters such as the ground-truth threshold and on how much the new data sample is different from the older one. In one embodiment, the oldest sample is deleted, and the new one is put in the buffer, if the new data sample has a DQI that is better than the oldest sample. In one embodiment, a determined older data sample is deleted and the new one is put in the buffer if there is a data sample that is older than a certain threshold (e.g., absolute or relative threshold in the bottom half of the buffer in terms of time of data collection) and this data sample has a DQI that is worse than the newest sample. In one embodiment, a randomly selected data sample is simply deleted, and the new one is put in the buffer. In one embodiment, if the oldest data sample among these is deleted and the new data sample is put in the buffer if there are a certain number of older data sample that have a DQI equal to or below that of the newest data sample. In one embodiment, the newer data is put in the buffer and one older data (e.g., the oldest, a randomly selected sample, the data with the lowest DQI, etc.) is deleted if the ground-truth of the new sample is outside a certain (statistical) margin of the collected data in the buffer (e.g., outside a certain standard deviation of the collected data, etc.).

There could be different criteria for the data collection (e.g., the ground-truth threshold, the DQI, or distribution, etc.) depending on how much data is already collected. For example, if the buffer is empty, the ground-truth threshold, DQI criteria could be relaxed while stricter thresholds could be configured to be used for cases where there are more than a certain amount of collected data in the buffer (e.g., one set of thresholds when buffer is below a first buffer level, second set of thresholds when the buffer is above the first buffer level and less than a second buffer level, third set of thresholds when buffer is above the second buffer level, etc.).

In one embodiment, a WTRU receives configuration for ground-truth reporting for network side data collection, where the configuration information includes one or more of the following: (a) criteria for data quality determination, (b) parameters (or ranges of parameters) corresponding to configured criteria, (c) configuration for data quality indicator determination (e.g., mapping function), (d) thresholds for ground-truth filtering, (e) collection purpose (training, fine tuning, monitoring), (f) maximum buffer sizes (e.g., for training buffer and fine-tuning buffer); and/or (g) ground-truth data collection window.

The criteria for data quality determination may include channel and/or associated conditions, data distribution, data completeness, and/or diversity of the ground-truth.

Channel and/or associated conditions may include (i) alignment of measured applicable conditions with the configured associated conditions; (ii) channel estimation accuracy (e.g., based on channel conditions if WTRU has a mapping between SNR ranges and channel estimation accuracy); and/or (iii) time-variability of the channel (e.g., based on Doppler, TDCP, WTRU speed). For performance monitoring, TDCP may be evaluated across a set of CSI-RS in a pre-determined time window. For temporal cases training, TDCP can be evaluated across one or more observation windows.

Data distribution may include (i) input data distribution drift (e.g., based on OOD score and/or distance metric) and/or (ii) latent distribution drift/alignment (e.g., in CSI compression use case).

Data completeness may be based on (i) if a subset of samples is missing (e.g., missing one or more sub-bands, missing one or more samples within the observation window (e.g., for temporal cases); (ii) no available CPUs for inference/measurements; and/or (iii) CSI-RS interferences.

Diversity of the ground-truths may be based on some statistical measurements or distances with respect to dataset clusters, median, etc.

Parameters (or ranges of parameters) corresponding to configured criteria may include (i) channel conditions (e.g., e.g., WTRU speed, Doppler spread, RSRP, SINR, SNR); (ii) data distribution parameters for first distribution (e.g., a mixed dataset for training a global model) and/or second distribution (e.g., a localized dataset for model fine tuning), such as first-order statistics (e.g., PDF, CDF, mean, range or interquartile range, median, etc.), anomalies rate, OOD detection, temporal statistics (e.g., for the observation window in temporal cases 1/2/3, such as moving average, correlation, coherence time); (iii) data completeness (e.g., CPU availability for measurements, CPU availability for inference, missed CSI-RS measurement (e.g., missed sub-band), missed samples within the observation window (e.g., for temporal cases); and/or (iv) diversity of the ground-truths (e.g., a distance/correlation (normalized between 0 and 1) from the sample median/mean/range/IQR/Std to the dataset cluster center).

The WTRU may then measure one or more ground-truths (e.g., CSI) on one or more received reference signals and measure metrics for one or more configured criteria for data quality determination. The ground-truth measurement may be one or more of the following: raw measured channel, eigen vectors of the measured channel, and/or a linear (e.g., pre-processing) transformation of the measured channel (e.g., when the AI/ML model operates in angular, delay, and/or Doppler domain).

The WTRU may determine one or more DQIs of the one or more ground-truths based on the measured one or more ground-truths and the configured mapping function, for example a first function of the scores associated with each configured criterion. The first function may be a weighted function of the scores, where the weights may be network configured. The score associated to a criterion may be a binary value or a real value in a range, where the range may be [0, 1]. The score associated to a criterion may be determined as a second function of the measured metrics associated to the criteria. The second function may be Equation 2 for channel and/or applicable conditions criterion. The second function may be Equation 3 For data distribution criterion. The second function may be Equation 4 for data completeness criterion. The second function may be all of the samples below a distance from the median of the configured distribution for the diversity of ground-truth sample criterion.

The WTRU may filer and store one or more ground-truths based on the determined one or more DQI, the configured ground-truth filtering thresholds, and previously stored filtered ground-truths. The WTRU may store a ground-truth sample in a second buffer (e.g., fine-tuning buffer) when the ground-truth sample distance to a second (e.g., localized) distribution is below a second configured threshold. The WTRU may store a ground-truth sample in a first buffer (e.g., the training buffer) when the ground-truth sample distance to a first (e.g., mixed) distribution is below a first configured threshold. The WTRU may store a ground-truth sample in a third buffer (e.g. monitoring buffer) if the configured data collection purpose is monitoring or when the ground-truth sample is out of distribution (OOD) with respect to both the first and second distribution.

The WTRU may select a reporting mode for the ground-truth sample stored in a buffer, as a function of the ground-truth sample stored in the buffer, available UL resources, and/or data collection purpose. In one embodiment the WTRU selects L1 reporting when reporting the stored ground-truth in a third buffer and/or L3 reporting when reporting the stored ground-truth in a first or second buffer.

The WTRU may report the stored ground-truth in a buffer in the selected UL resource. The WTRU may also report the DQI of one or more stored ground-truth in a buffer.

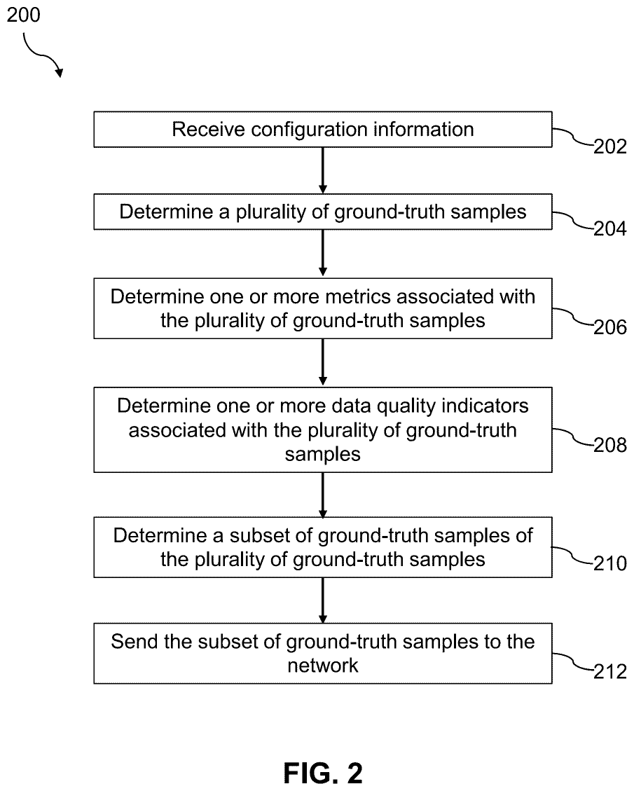

FIG. 2 is a flowchart diagram 200 illustrating an example method according to an embodiment. The method may be implemented by a WTRU. At 202, the WTRU receives configuration information. The configuration information may indicate information related to ground-truth reporting. The information related to ground-truth reporting may comprise data quality criteria, a data quality indicator, and a threshold associated with ground-truth filtering. At 204, the WTRU determines a plurality of ground-truth samples based on one or more received reference signals. At 206, the WTRU determines one or more metrics associated with the plurality of ground-truth samples. The one or more metrics associated with the plurality of ground-truth samples may be based on the data quality criteria, At 208, the WTRU determines one or more data quality indicators associated with the plurality of ground-truth samples. The one or more data quality indicators associated with the plurality of ground-truth samples may based on the one or more metrics and the data quality indicator configuration. At 210, the WTRU determines a subset of ground-truth samples of the plurality of ground-truth samples. The subset of ground-truth samples may be determined based on the one or more data quality indicators, the threshold associated with ground-truth filtering, and the plurality of ground-truth samples. At 212, the WTRU sends the subset of ground-truth samples to the network.

1. A wireless transmit/receive unit (WTRU) comprising:
a processor configured to:
receive configuration information, wherein the configuration information indicates information related to ground-truth reporting, and wherein the information related to ground-truth reporting comprises data quality criteria, a data quality indicator configuration, and a threshold associated with ground-truth filtering;
determine a plurality of ground-truth samples based on one or more received reference signals;
determine one or more metrics associated with the plurality of ground-truth samples based on the data quality criteria;
determine one or more data quality indicators associated with the plurality of ground-truth samples based on the one or more metrics and the data quality indicator configuration;
determine a subset of ground-truth samples of the plurality of ground-truth samples based on the one or more data quality indicators, the threshold associated with ground-truth filtering, and the plurality of ground-truth samples; and
send the subset of ground-truth samples to a network entity.

2. The WTRU of claim 1, wherein the data quality indicator configuration comprises an indication of a mapping function.

3. The WTRU of claim 1, wherein the information related to ground-truth reporting comprises one or more of: (i) parameters associated with the data quality criteria, (ii) an indication of a maximum buffers size, or (iii) a ground-truth data collection window, and
wherein the parameters associated with the data quality criteria comprise one or more of: (i) one or more channel conditions, or (ii) one or more data distribution parameters associated with a distribution of data.

4. (canceled)

5. The WTRU of claim 1, wherein the data quality criteria comprise one or more of: (i) one or more channel conditions, (ii) an indication of a data distribution, (iii) an indication of data completeness, or (iv) an indication of a ground-truth diversity.

6. The WTRU of claim 1, wherein the plurality of ground-truth samples comprise measurements associated with one or more of: (i) a channel, (ii) an eigen vector of the channel, or (iii) a linear transformation of the channel.

7. The WTRU of claim 1, wherein the processor is configured to:
send the one or more data quality indicators associated with the subset of ground-truth samples to the network entity.

8. The WTRU of claim 1, wherein the processor is configured to:
determine the one or more data quality indicators associated with the plurality of ground-truth samples based on two or more functions.

9. The WTRU of claim 1, wherein the processor is configured to:
determine a reporting mode for the subset of ground-truth samples based on one or more of: (i) an amount of data stored in a buffer, (ii) an availability of uplink resources, or (iii) a data collection purpose provided via the information related to ground-truth reporting; and
send the subset of ground-truth samples to the network entity based on the reporting mode, wherein the reporting mode is associated with layer 1 signaling or layer 3 signaling.

10. The WTRU of claim 1, wherein the processor is configured to:
determine a distance between the subset of ground-truth samples and a configured distribution; and
determine whether to use layer 1 signaling or layer 3 signaling to send the subset of ground-truth samples to the network entity based on the distance between the subset of ground-truth samples and the configured distribution.

11. A method implemented by a wireless transmit/receive unit (WTRU), the method comprising:
receiving configuration information, wherein the configuration information indicates information related to ground-truth reporting, and wherein the information related to ground-truth reporting comprises data quality criteria, a data quality indicator configuration, and a threshold associated with ground-truth filtering;
determining a plurality of ground-truth samples based on one or more received reference signals;
determining one or more metrics associated with the plurality of ground-truth samples based on the data quality criteria;
determining one or more data quality indicators associated with the plurality of ground-truth samples based on the one or more metrics and the data quality indicator configuration;
determining a subset of ground-truth samples of the plurality of ground-truth samples based on the one or more data quality indicators, the threshold associated with ground-truth filtering, and the plurality of ground-truth samples; and
sending the subset of ground-truth samples to a network entity.

12. The method of claim 11, wherein the data quality indicator configuration comprises an indication of a mapping function.

13. The method of claim 11, wherein the information related to ground-truth reporting comprises one or more of: (i) parameters associated with the data quality criteria, (ii) an indication of a maximum buffers size, or (iii) a ground-truth data collection window, and
wherein the parameters associated with the data quality criteria comprise one or more of: (i) one or more channel conditions, or (ii) one or more data distribution parameters associated with a distribution of data.

14. (canceled)

15. The method of claim 11, wherein the data quality criteria comprise one or more of: (i) one or more channel conditions, (ii) an indication of a data distribution, (iii) an indication of data completeness, or (iv) an indication of a ground-truth diversity.

16. The method of claim 11, wherein the plurality of ground-truth samples comprise measurements associated with one or more of: (i) a channel, (ii) an eigen vector of the channel, or (iii) a linear transformation of the channel.

17. The method of claim 11, further comprising:
sending the one or more data quality indicators associated with the subset of ground-truth samples to the network entity.

18. The method of claim 11, wherein
determining the one or more data quality indicators associated with the plurality of ground-truth samples is based on two or more functions.

19. The method of claim 11, wherein
determining a reporting mode for the subset of ground-truth samples is based on one or more of: (i) an amount of data stored in a buffer, (ii) an availability of uplink resources, or (iii) a data collection purpose provided via the information related to ground-truth reporting; and
sending the subset of ground-truth samples to the network entity is based on the reporting mode, wherein the reporting mode is associated with layer 1 signaling or layer 3 signaling.

20. The method of claim 11, further comprising:
determining a distance between the subset of ground-truth samples and a configured distribution; and
determining whether to use layer 1 signaling or layer 3 signaling to send the subset of ground-truth samples to the network entity based on the distance between the subset of ground-truth samples and the configured distribution.

21. The WTRU of claim 1, wherein at least one ground-truth sample of the plurality of ground-truth samples comprises a true channel response at a prediction instance.

22. The method of claim 11, wherein at least one ground-truth sample of the plurality of ground-truth samples comprises a true channel response at a prediction instance.
